(19) United States
(12) Patent Application Publication
(10) Pub. No.: US 2023/0281526 A1
(43) Pub. Date: Sep. 7, 2023

(54) Methods and Systems for Real Time Mission Coordination of Law Enforcement Operations

(71) Applicant: Pryme Infil, Reno, NV (US)

(72) Inventors: Jarred Pereira, Vacaville, CA (US); Michael Cowgill, Fairfield, CA (US)

(73) Assignee: Pryme Infil, Reno, NV (US)

(21) Appl. No.: 18/177,631

(22) Filed: Mar. 2, 2023

Related U.S. Application Data
(60) Provisional application No. 63/315,811, filed on Mar. 2, 2022.

(51) Int. Cl. G06Q 10/0631; G06Q 50/26

(52) U.S. Cl. CPC G06Q 10/063114; G06Q 50/265

(57) ABSTRACT

Methods and systems for a real-time mission coordination platform for law enforcement operations and the like that allows for the generation of a standardized operational plan are described herein. The platform may be a cloud-based application in communication with a local data repository for operation-related data. A user on a network-enabled mobile device may use the application to coordinate an operational plan, notify team members, communicate with team members, disseminate tasks, produce operation-related data to each user, and log any information obtained during and after the operation. All data gathered during the law enforcement operation may be stored by the application for subsequent use (e.g., in training, reviews, discovery, chain of custody evidence, etc.). The operation data may be encrypted and stored on a blockchain for subsequent proceedings.

### CROSS-REFERENCE TO RELATED APPLICATIONS

This application is a non-provisional application conversion of, and claims priority to, prior U.S. provisional application Ser. No. 63/315,811, entitled: Real-Time Mission Coordination, and filed on Mar. 2, 2022.

### TECHNICAL FIELD

Methods and systems for a real-time mission coordination platform for law enforcement operations and the like, that allow for the generation of a standardized operational plan are described herein. The platform may be a cloud-based application in communication with a local data repository for operation-related data. A user on a network-enabled mobile device may use the application to coordinate an operational plan, notify team members, communicate with team members, disseminate tasks, produce operation-related data to each user, and log any information obtained during and after the law enforcement operation. All data gathered during the operations may be stored by the application for subsequent use (e.g., training, reviews, discovery, evidentiary chain of custody, etc.). The operational data may be encrypted and stored on a blockchain for subsequent proceedings.

### BACKGROUND OF THE INVENTION

Law enforcement operations present a variety of challenges, especially in the coordination of tools/resources for an emergency callout operation (e.g., hostage rescue, active shooter, barricaded suspect, high-risk warrant service, etc.). These tools/resources benefit from a well-defined operational plan that provides for: notifying team members; identifying available team members; coordinating team member responses; tracking team members and other responding personnel; uploading associated documents such as, e.g., photographs of the subject and location, intel packets, warrants, and criminal record histories; creating an operational plan that details the specific of the operation (e.g., the situation, mission, execution, admin/logistics, and communication, etc.); viewing, manipulating and marking up a live map of the location specified for the operation; and ultimately storing the operational related data for later use (e.g., training or court proceedings).

In an embodiment, the present invention provides a computer-based platform accessible to network-enabled mobile devices for development and real-time communication of an operational plan for a law enforcement event. The multi-functionality of the platform allows for (1) pre-event management of available personnel and their calendars; (2) use of templated alerts and messages to communicate with potential team members to staff the assignments required for the operation; (3) use of industry standard templated tools for generating an operational plan and coordinating resources, to expedite and simplify real-time planning; (4) operational personnel to communicate and assist in the overall organization of the operation, keeping all members informed and in synchronization with each other; (5) uploading of documents and files associated with the operation such as photographs, legal documents such as warrants and criminal record histories; (6) viewing, manipulating and marking up a live map of a specified location; (7) archiving all operational related data under a unique operations identification number; (8) storing the archived operational data in block-chain encrypted files, easily retrievable for future needs; (9) viewing drone images in real-time; (10) utilizing mobile device geo-positioning data to track team member movement and location in real-time; and (11) training exercises.

### BRIEF DESCRIPTION OF THE FIGURES

This disclosure is illustrated by way of example and not limitation in the figures of the accompanying drawings, in which like references indicate similar elements, and in which:

FIG. 1 is a diagram of an example computing system that may be used with some embodiments of the present invention.

FIG. 2 shows an overall flow diagram for real-time operational coordination platform for law enforcement operations using a standardized operational plan according to an exemplary embodiment.

FIG. 3 is a screenshot from a mobile application showing an exemplary launch page, according to various embodiments.

FIG. 4 is a screenshot from a mobile application showing an exemplary notification template, according to various embodiments.

FIG. 5 is a screenshot from a mobile application showing a user accepting a received notification, according to various embodiments.

FIG. 6 is a screenshot from a mobile application showing a templated operation plan checklist, according to various embodiments.

FIG. 7 is a screenshot from a mobile application showing a formatted operation plan, according to various embodiments.

FIG. 8 is a screenshot from a mobile application showing an exemplary sub-section template as part of a formatted operation plan, according to various embodiments.

FIG. 9 is a screenshot from a mobile application showing an exemplary sub-section template including prompts for image files and associated description, according to various embodiments.

FIG. 10 is a screenshot from a mobile application showing an exemplary section in an operation plan for a live map of an operation site, according to various embodiments.

FIG. 11 shows a simplified block diagram of an embodiment of a distributed computer system supporting a real-time operational coordination platform for law enforcement operations using a standardized operational plan.

FIG. 12 shows a diagram of an example of a computing device from a system for real-time operational coordination platform for law enforcement operations using a standardized operational plan.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

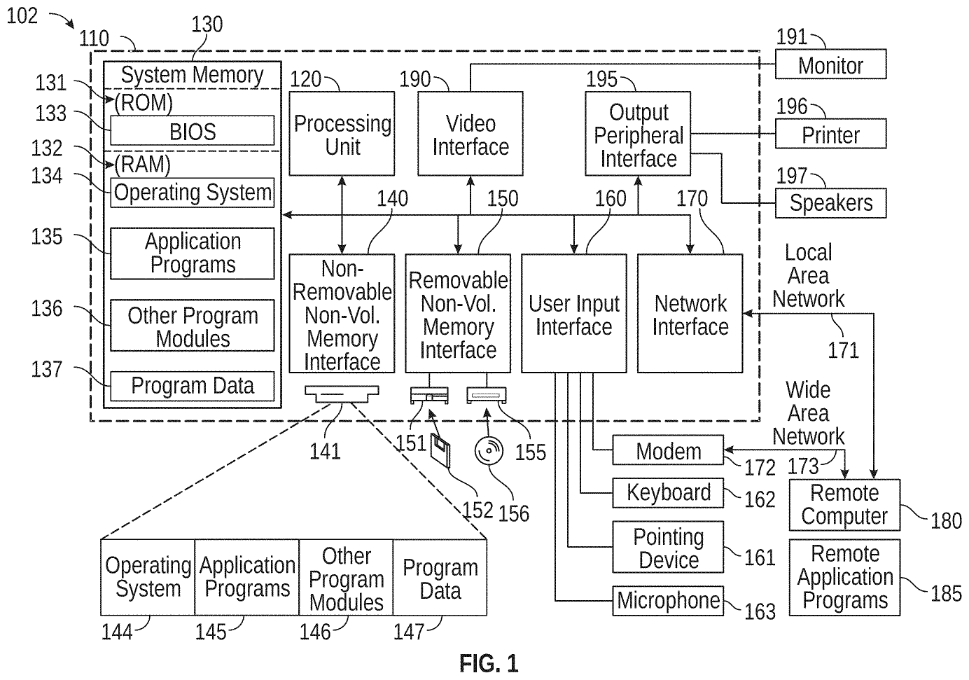

FIG. 1 is a diagram of an example computing system that may be used with some embodiments of the present invention. The computing system 109 is only one example of a suitable computing system, such as a mobile computing system, and is not intended to suggest any limitation as to the scope of use or functionality of the design. Neither should the computing system 109 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 109 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 1, the computing system 109 may include, but are not limited to, a processing unit 120 having one or more processing cores, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 109 typically includes a variety of computer readable media. Computer readable media can be any available media that can be accessed by computing system 109 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 109. Communication media typically embodies computer readable instructions, data structures, or program modules.

The system memory 130 may include computer storage media in the form of volatile and/or nonvolatile memory such as read only memory (ROM) 131 and random access memory (RAM) 132. A basic input/output system (BIOS) 133, containing the basic routines that help to transfer information between elements within computing system 109, such as during start-up, is typically stored in ROM 131. RAM 132 typically contains data and/or program modules that are immediately accessible to and/or presently being operated on by processing unit 120. By way of example, and not limitation, FIG. 1 also illustrates operating system 134, application programs 135, other program modules 136, and program data 137.

The computing system 109 may also include other removable/non-removable volatile/nonvolatile computer storage media. By way of example only, FIG. 1 also illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing system 109. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A user may enter commands and information into the computing system 109 through input devices such as a keyboard 162, a microphone 163, and a pointing device 161, such as a mouse, trackball or touch pad or touch screen. Other input devices (not shown) may include a joystick, game pad, scanner, or the like. These and other input devices are often connected to the processing unit 120 through a user input interface 160 that is coupled with the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

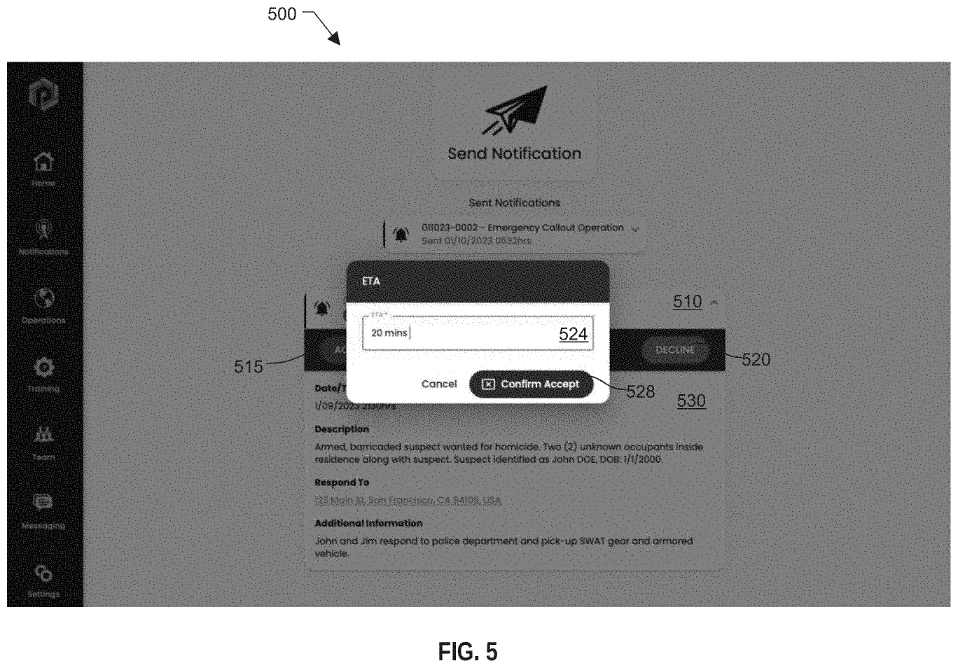

The computing system 109 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing system 109. The logical connections depicted in FIG. 5 include a local area network (LAN) 171 and a wide area network (WAN) 173, but may also include other networks. Such networking environments are commonplace in offices, enterprise-wide computer networks, intranets and the Internet.

When used in a LAN networking environment, the computing system 109 may be connected to the LAN 171 through a network interface or adapter 170. When used in a WAN networking environment, the computing system 109 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computing system 109, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some embodiments of the present invention may be carried out on a computing system such as that described with respect to FIG. 1. However, some embodiments of the present invention may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol (WAP) to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

In exemplary embodiments, the server-based application and the network-enabled client devices running the client version of the application provide an environment for creating, provisioning, managing and data storage of a law enforcement operational plan. The team leader device employs template driven interfaces to create a law enforcement operation event. The team leader device can use templates and previously stored team personnel information to invite the team operators to participate in the event. The team leader device uses the application to populate the event with key documents and information. The operator devices receive messages, photographs and other key documents that are part of the law enforcement event. The operator devices can also input data into the live operational plan, such as, for example, geo-positioning data that represents the operator device location. Other documents and file types can also be input by the operator devices, such as maps, diagrams, photographs and the like. The amalgam of these inputs is processed by the application running on the application server to output in real time the state of the law enforcement event to the team leader device and the operator devices. The consolidation and management features of the application platform eliminates the need for communication over multiple different communications platforms.

The application user will have to use a user name and password to access the application, either on a computing device located in a police agency facility or on a mobile computing device in the field. Multi-factor authentication using various known techniques as authentication applications generating verification codes or push notifications such as e.g., Microsoft Authenticator, may be used to increase secure access to the application. It is also possible to pre-assign application permissions to specific user names or roles to control user access to the various services provided by the application. These permissions may also be adjusted from their normal setting as a function of the security of the user's network connection to the application server.

The application uses traditional client device modules running on the local mobile device in communication with an application server and related databases to enable the functionalities described above. The application may employ a websocket push system to keep persistent connections, primarily for real-time messaging between the team leader and operators or intra-operators. This websocket push mechanism also allows for alerting all devices that there is an update to the operation plan and may trigger a refresh without any manual intervention.

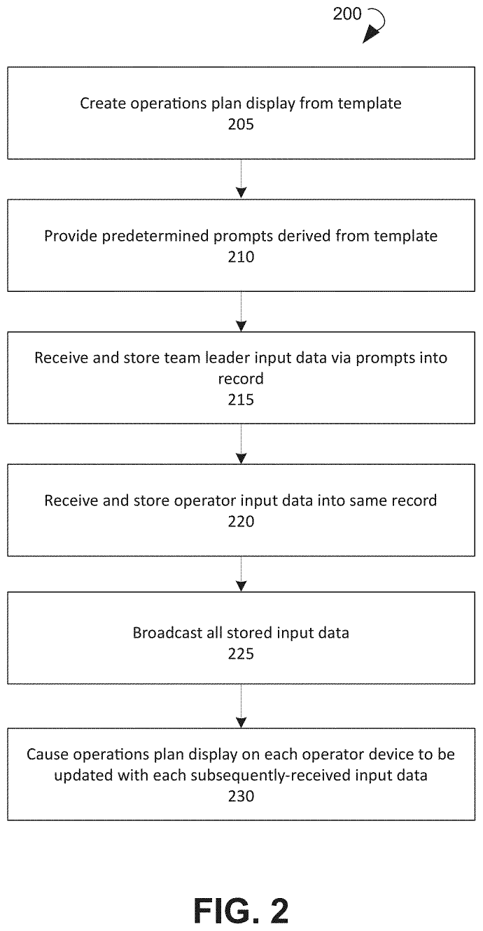

FIG. 2 shows an overall flow diagram for an exemplary method 200 for a real-time operational coordination platform for law enforcement operations using a standardized operational plan according to an exemplary embodiment. The platform may be a cloud-based application in communication with a local data repository for operation-related data. A processor of an application server having memory may create a law enforcement operational plan display from a stored template in response to receiving a request for a law enforcement operational plan from a team leader device over a network connection at step 205. In order to create the operational plan display, the team leader device may be required to have been previously authenticated as being an administrator by a security server.

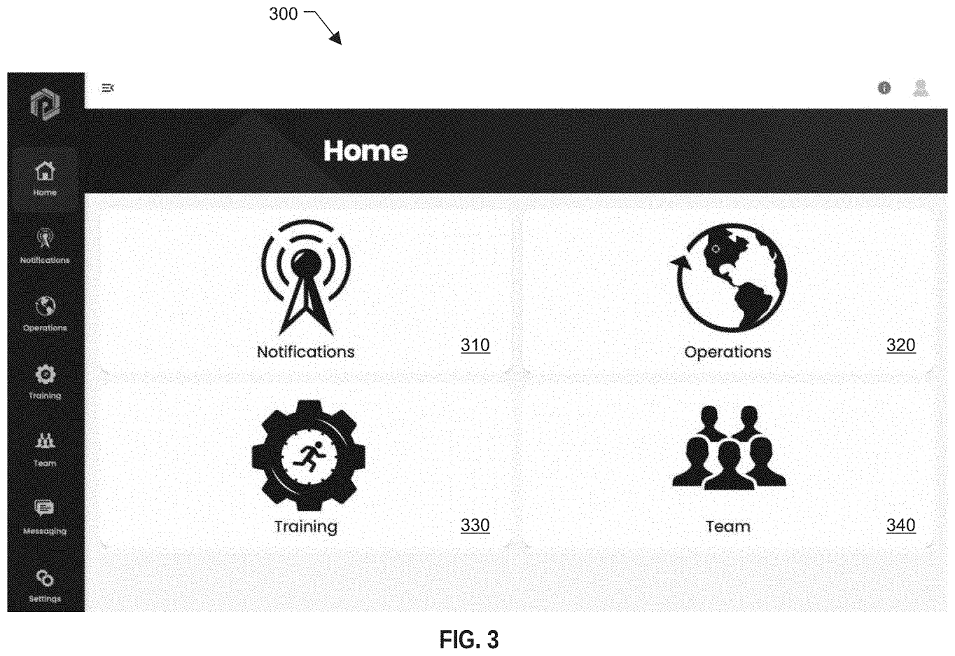

Screenshots from the platform illustrate exemplary embodiments of various user interfaces used by the operational coordination application to perform the various processes and steps used to provide support and documentation for various operations. FIG. 3 is a screenshot 300 from a mobile application showing an exemplary launch page, according to various embodiments, which may be used in the process of generating and submitting a request to create the operational plan display. Four selectable operations may be provided on home page 300 displayed in the screenshot:
Notifications Option 310: takes user to a page displaying all, current, and/or archived notifications received. When a specific notification is selected, the user will have access to a hyperlink corresponding directly to an operation or training event, which is specified by an associated file/case number.
Operations Option 320: takes user to a page displaying initiated, active, completed, and/or archived operations. When a specific operation is selected, the user will have access to various tools/resources, depending on their role, pertaining to that operation to include: Creating/viewing a templated operational plan, tracking responding personnel, view/manipulating a live map, messaging team members, uploading documents, viewing drone footage, utilizing a computer assisted dispatch note taking system, utilizing a crisis negotiation note taking system, and creating/viewing an after-action report.
Training Option 330: takes user to a page displaying initiated, active, completed, and/or archived training events. When a specific training event is selected, the user will have access to various tools/resources, depending on their role, pertaining to that training event to include: creating/viewing a templated training outline, tracking responding personnel, view/manipulating a live map, messaging team members, and creating/viewing an after-action report. page allowing a user to create a training outline for an upcoming training day based on a template when selected.
Team Option 340: takes user to a page displaying information regarding a particular team, including: team policies and procedures, event calendar, and team roster.
   Selecting notifications option 310 may also present an operational organizer (also referred to herein as the team leader, commander, etc.) device user with the option to complete and disseminate a templated notification to team members, pertaining to a specific event (e.g., emergency callout, planned operation, training event, and/or a custom message, etc.). Once disseminated, a hyperlink will be produced for certain events, taking the team leader device user to a page to create an operational plan.

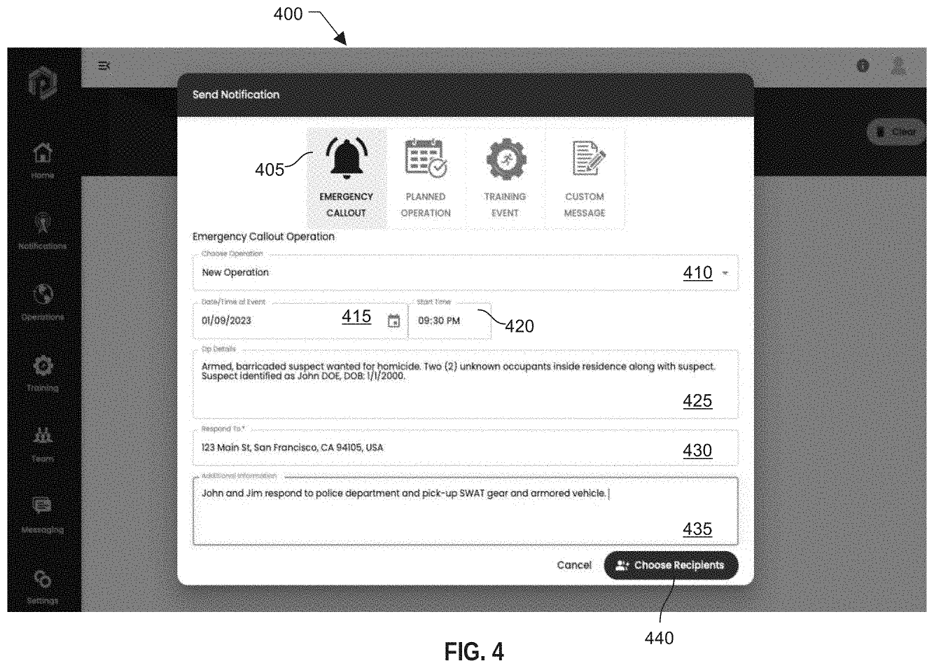

In response to receiving the request, the processor may provide, for display on the team leader device, a plurality of predetermined prompts for receiving specified data, the predetermined prompts being derived from the stored template at step 210 of method 200. The processor may then receive, via the network connection, and store team leader input data from the team leader device associated with one or more of the displayed predetermined prompts at step 215 to populate the template. The team leader input data may include messages from the team leader device, identities and geo-locations associated with a plurality of operator devices, files representing documents and image data associated with the law enforcement operational plan, and customizable image data, among other specified data reference by the predetermined prompts. FIG. 4 is a screenshot from a mobile application showing an exemplary notification template 400 for a law enforcement operational plan, according to various embodiments. As seen in template 400, the law enforcement operational plan display may be a graphic user interface illustrating a plurality of fields associated with different data associated with the law enforcement operational plan. Different types of templates may be presented in response to the user selecting one of the four types of notifications presented: Emergency Callout, Planned Operation, Training Event, and Custom Message (more or fewer template options may be provided, depending on the context). If “callout operation” is selected, the app will require the user to complete the various fields in the predetermined template for callout operations. If “pre-planned operation” is selected, the app may require the user to upload the pre-planned operation from a data storage location. This will then populate all the necessary fields of the corresponding template to the type of operation.

After selecting the Emergency Callout icon 405, the user may be presented with a templated message with predefined fields for entry of data relating to the operation such as Choose Operation option 410, date and time options 415 and 420 respectively, an Op details field 425, response location 430 and additional information field 435. Once the fields are populated, the user can then “Choose Recipients” by clicking on the button 440 at the bottom right of the interface. Selecting button 440 may cause a different interface to be presented, where the user of the authenticated team leader device may select or manually input contact information for individuals or teams desired for the operation. After the recipients have been selected, the notification message created via template 400 may be transmitted via network connection to operators selected as recipients.

Once the operation notification is disseminated, the operators may receive a phone call/sms/push alert notification. The term “operators” is a law enforcement/military term used for personnel, team member, etc. This term may differ depending on the organization utilizing the software application. Retrieval of the notification message, which may be located in an in-app notification inbox for example, by an operator device may cause a notification interface to be presented. FIG. 5 is a screenshot 500 from a mobile application showing a user accepting a received notification via such a notification interface 510, according to various embodiments. The notification interface 510 includes an op information portion 530 including the team leader input data provided when the notification was created, as described above. The operator notification interface 510 may also provide selectable options to accept 515 or decline 520 being assigned to the operation. In response to selection of the accept option 515, a pop-up interface may be provided in some embodiments requesting that the operator provide their estimated arrival time in a corresponding field 524. Once the arrival time has been provided, the operator may confirm acceptance of the operation assignment by selecting confirm accept option 528.

Once the operators receive the notification/details displayed on screenshot 500, and select “accept,” they may be placed on an “available operators” list for the team leader who is creating the operation plan and conducting the briefing. The terms “Team leader” or “Commander” are law enforcement/military terms used for manager, supervisor, leader, etc. These terms may differ depending on the organization utilizing the software application. If the operators select “decline”, they may be asked to provide a comment as to why (i.e. vacation, child care, on duty, staffing levels, etc.) for record keeping purposes.

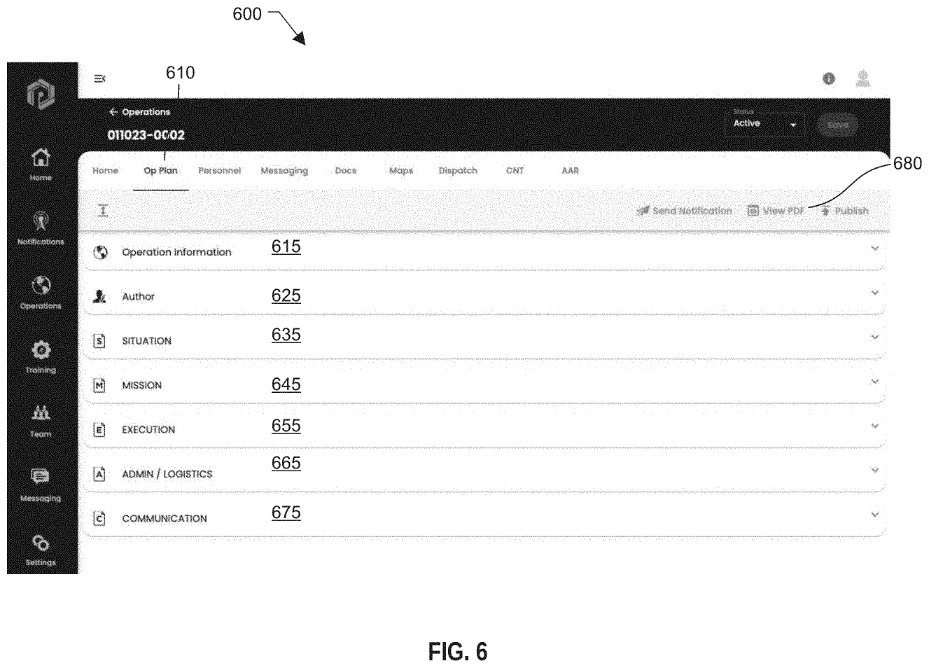

From the team leader device perspective, once the notification to contact teams and individuals has been transmitted, the user of the team leader device may continue to complete predetermined prompts in the operation plan template. The operation plan template may present a set of sections, and the user may input data that corresponds with each section. Those sections may then automatically be saved to a “live PDF” fixed-field document that is filled out/updated as each predetermined prompt is filled out/updated. FIG. 6 is a screenshot 600 from a mobile application showing a templated operation plan checklist, according to various embodiments. The checklist depicted in screenshot 600 may automatically be presented on the team leader device in response to the notification being sent previously, or may be selected as an option from an operations home page (e.g., presented in response to selection of the operations option 320 from home page 300) by the user of the team leader device in various embodiments. The checklist, which may be displayed at any time in response to the user selecting the Op Plan tab 610, may include the following selectable predetermined sections:
Operation Information section 615: allows the user of the team leader device to populate various prompts relating to different aspects of the operation, such as date, operation type, and case number.
Author section 625: allows the user to provide information relating to the author(s) of the operational plan, including the user of the team leader device, or any operators who may have input information into the operational plan.
Situation section 635: allows the user to provide information about the situation pertaining to the operation, including any narrative details provided by the user of the team leader device, warrant information, case background, providing objective location information, subject/suspect information, vehicles involved in the situation, and the like.
Mission section 645: allows the user to provide information regarding the overall objection of the operation.
Execution section 655: allows the user to provide information regarding execution of the Op, including concept of operation, proposed tactics, assignment of team members to specific tasks, teams, and vehicles, and contingencies. May also display team GPS locations, based on each operator device providing the location data position of each operator. Furthermore, may also provide drone footage in real-time during the operation.
Admin/Logistics section 665: allows the user to provide briefing details, establish command posts and control points, list medical information of nearby medical facilities, air support, and manage equipment used for the operation.
Communication section 675: allows the user to set radio channels, and transmit/receive deconfliction notifications for agencies not involved in the operation (which may all be saved for discovery/litigation purposes).

While a user of the team leader device may be presented with all of the checklist sections displayed in screenshot 600 when selecting the Op Plan tab 610, when an operator selects the Op Plan tab on their user interface, only a subset of the sections may be displayed, reflecting the fact that operators do not have the same access/control over the operational plan as team leaders. At any time, the user of the team leader device may select the View PDF option 680 to view the live PDF of the operation plan.

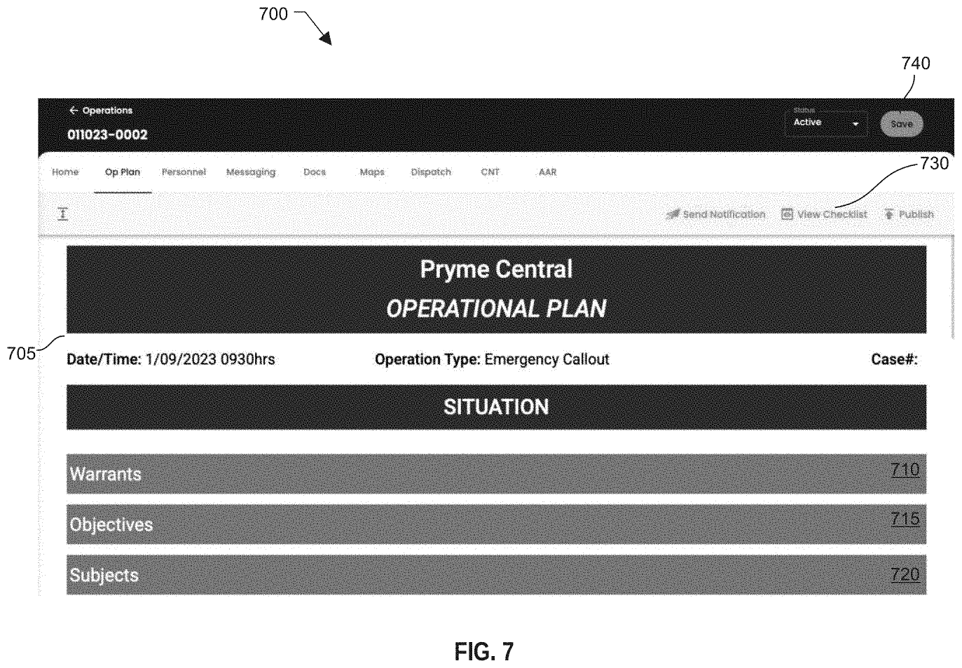

FIG. 7 is a screenshot 700 from a mobile application showing a formatted operation plan 705 “Live PDF,” according to various embodiments. Live PDF 705 may include corresponding sections to the operations plan checklist in screenshot 600, except in fixed, un-editable format. Sub-sections of the Situation section are displayed in Live PDF 705, including sub-sections for warrants 710, objectives 715, and subjects 720 that are populated after receiving user input from either the team leader device or from operator devices. More sections may be displayed when the user scrolls the Live PDF 705. At any time, desired by the user of the team leader device, the Live PDF 705 can be broadcast as an operational plan for all members of the team to view on their corresponding operator devices by saving the Live PDF 705 using selectable save button 740, allowing team members to view updates to the operation plan in real time. Moreover, if the user of the team leader device wishes to edit or amend portions of the operational plan, they may select the View Checklist link 730. For pre-planned operations, the user may transmit a notification to operation personnel in response to selecting the send notification button displayed.

Returning to method 200, the processor of the operations management system may receive, via the network connection from the plurality of operator devices, and store operator input data including messages, geolocation information and other operational data at step 220. The operator input data may be added directly to the operational plan template, or may be added to a separate tab of the operation, such as the Maps tab (e.g., in the case of device geolocational information) or the Messaging tab (e.g., in the case of messages being sent as operator input data). As team leader input data and operator input data is received, the processor of the application server may broadcast, over the network connection using a websocket push system to maintain persistent connections, the stored team leader input data and the stored operator input data to the plurality of operator devices at step 225. The broadcasting may cause the stored team leader input data and stored operator input data to be displayed in a field of the law enforcement operational plan display of each of the plurality of operator devices, as part of a Live PDF, for example.

As noted above, team leader input data and/or operator input data may be received within prompts of the operational plan template. Returning to screenshot 600, selection of any of the sections of the operational plan template checklist may cause the section to be expanded, revealing sub-sections that include the predetermined prompts for one or more users to provide input data to enrich the operational plan Live PDF. For example, the Situation section may be expanded to include sub-sections for narrative details provided by the user of the team leader device, warrant information, case background, providing objective location information, subject/suspect information, and/or vehicles involved in the situation. A sub-section may in turn be selected to provide a user with a set of prompts to receive data provided by the team leader device and/or an operator device.

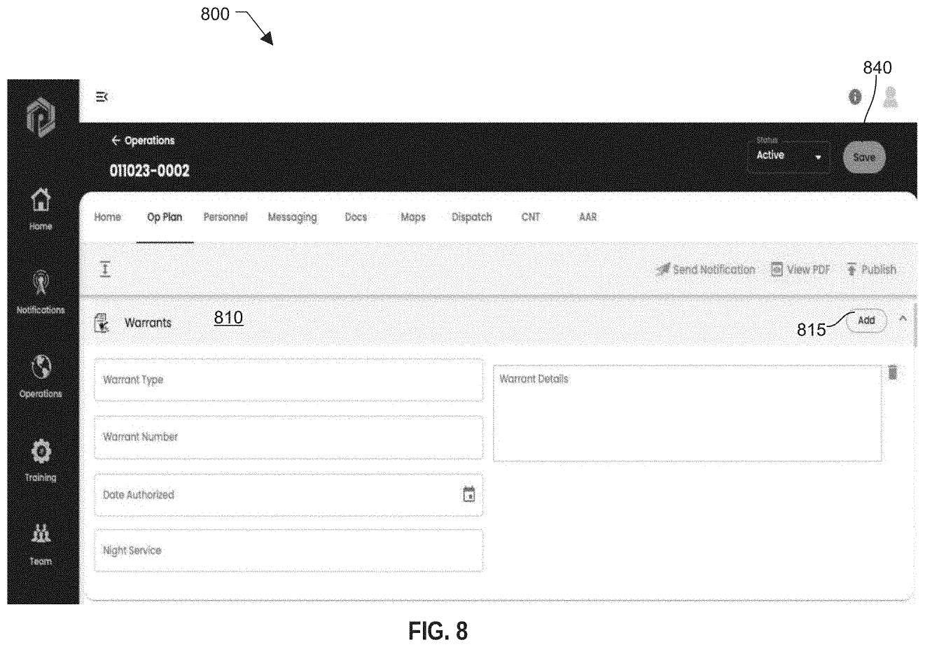

FIG. 8 is a screenshot 800 from a mobile application showing an exemplary warrant sub-section template as part of the formatted operational plan, according to various embodiments. Warrants sub-section 810 includes a plurality of prompts for receiving user input regarding warrants associated with the operational plan. Once the fields have been populated with user input, a user may select the Add button 815 to add the user input to the operation plan and/or the Live PDF. The user may be automatically returned to the checklist shown in screenshot 600 after selecting the Add button 815 in some embodiments. The save button 840 may be selected to immediately broadcast the user input to team members via the network connection between the devices and the cloud server in communication with the devices.

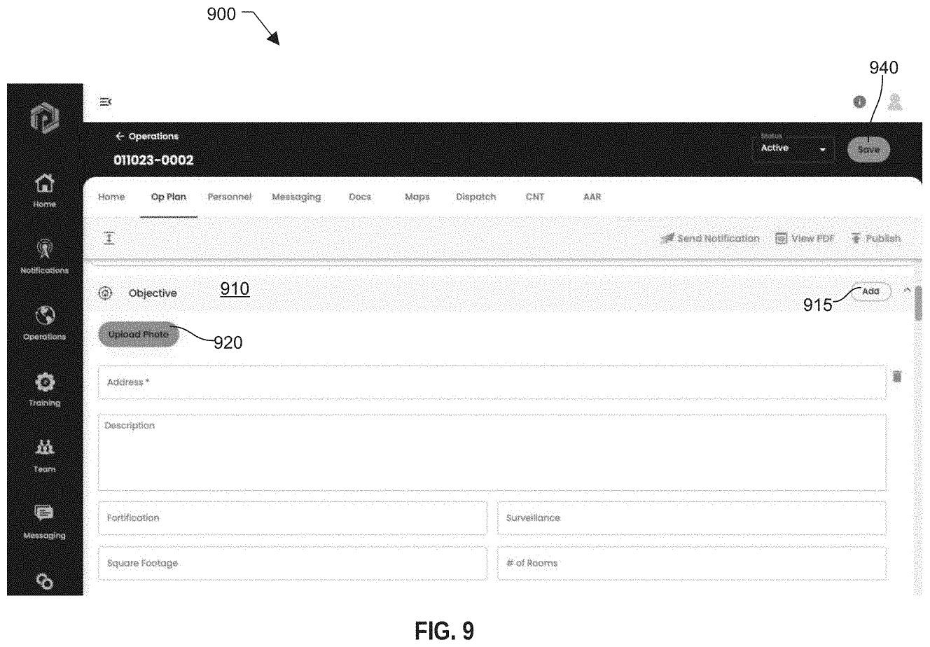

Different types of prompts may be presented as appropriate to the section or sub-section of the operation plan and user inputs. FIG. 9 is a screenshot 900 from a mobile application showing an exemplary objective sub-section template including prompts for image files and associated description, according to various embodiments. Objective sub-section 910 includes an upload photo button 920 that allows the user of the team leader device to upload from local storage images taken of the objective location for the operation. The uploaded images may be accompanied by text description of various facets of the objective location in prompts of the objective sub-section 910 as shown. Once the fields have been populated with user input, a user may select the Add button 915 to add the user input to the operation plan and/or the Live PDF. The user may be automatically returned to the checklist shown in screenshot 600 after selecting the Add button 915 in some embodiments. The save button 940 may be selected to immediately broadcast the user input to team members via the network connection between the devices and the cloud server in communication with the devices.

Returning to screenshot 600, the additional tabs displayed may provide additional operation-related information to supplement the operational plan. For example, the Personnel tab may cause an interface to be displayed that includes each member of the team of the operation, their acceptance/denial status of the operation notification, and the ETA they submitted with their response to the notification. Additional information may be added to the personnel interface, including radio call sign, task, team assignment, and/or vehicle assignment, for each team member during the course of the operation. The Documents tab may provide all documents, such as warrants, associated with the operation when selected by a user of the application.

When the Messaging tab is selected, an interface may be displayed that allows team members to communicate to individuals or entire groups during the operation. Each message thread shown in the Messaging tab interface may be automatically be saved for discovery/litigation purposes. When the individual operator is assigned to a message group, and that group receives a message, the app will update with a message alert. If the operator is not assigned to a message group, they will not have access to view those messages, nor will they receive a notification.

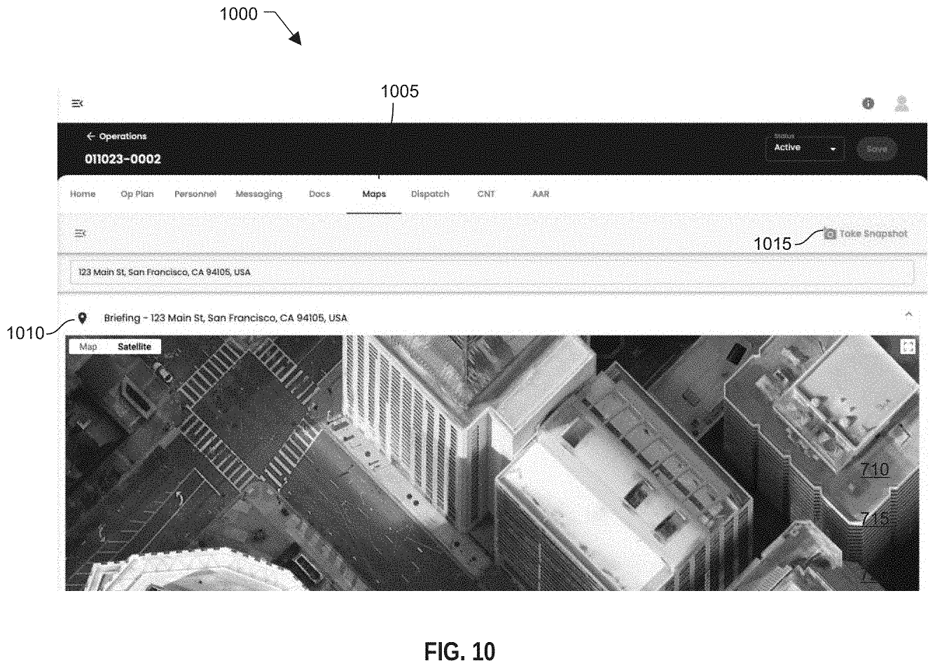

The Maps tab may cause one or more images of the operation site and associated map images to be displayed in response to being selected. All locations referenced by the sections of the operational plan checklist, including operation objectives, briefing locations, command post locations, staging locations, and others, can be viewed in the map interface with live maps, which may be periodically updated by the processor. FIG. 10 is a screenshot 1000 from the mobile application showing an exemplary section in an operation plan for a live map 1010 of an operation site, according to various embodiments. Live map 1010 may be displayed in response to selection of the Maps tab 1005. Also, as shown, a screenshot of live map 1010 can be taken in response to selection of corresponding icon 1015, to be edited by a user on an operator device. The screenshot taken of the live map 1010 may then be automatically saved, and an icon may be created below its corresponding live map 1010. In some embodiments, the screenshot of live map 1010 may also be linked to its respective section in the operational plan checklist of the Op Plan to facilitate reference by the team leader and operators.

In addition to locations, the Map tab may also include the team's GPS location data, displayed as individual operator positions overlaid on a live map in some embodiments. To obtain the GPS locations of each team member, a message may be sent to each operator device, prompting the user of the operator devices to share their locations. When this request is accepted, the operator devices may periodically send their locations automatically for display on a live map. In some embodiments, the geolocations of the operator devices may be received at the processor via an application programming interface between each operator device client application in communication with the processor via the network connection and geolocation services running on the operator devices.

Returning to screenshot 600, additional image information may be displayed in response to selection of the Drone Footage tab, which may provide an interface displaying live drone footage during the operation (e.g., using a URL of a drone footage website or an API to the drone video software web application). The Dispatch and Crises Negotiation Team (CNT) tabs may cause interfaces allowing for Dispatch and CNT teams to log their communications with the operators and team leader separately for easy access. The notes provided by Dispatch and/or CNT teams may be automatically date/time stamped, along with an identification the user who authored the note. Finally, the after-action report (AAR) tab may allow the user, using substantially identical functionality to the Op Plan tab, to fill out templated sections of an AAR checklist that corresponds to a separate Live PDF. Once completed/finalized, that AAR Live PDF can be uploaded to the Documents section for the team to review.

By changing the status of the operation from “Active” to “Completed,” the user of the team leader device may trigger the processor to transmit a push-notification to a Supervisor or Commander user, who must be authenticated as such before being able to access the operation and review the operation's contents (e.g., the operational plan, messaging, documents, notes, and after-action report). Upon completion of their review, the Supervisor or Commander can change the operation status to “Archived.” This then saves/locks all data from any further editing/manipulation for that specific operation. The data is then stored under the corresponding file/case number at a specified data storage location, such as a database. In some embodiments, the database may be a blockchain database, limiting access to records to select users having key privileges to transfer the records to other users, and also making the records public and largely immutable.

As noted above, it is contemplated that input data will be entered in real-time by both the team leader and various operators in response to evolving conditions in the operation. In response, at step 230 of method 200, the processor may cause the operational plan display of each of the plurality of operator devices (and the team leader device) to be updated substantially in real-time with subsequently-received team leader input data and subsequently-received operator input data, ensuring that the operational plan displayed provides the most up-to-date information across all channels to the team during the operation.

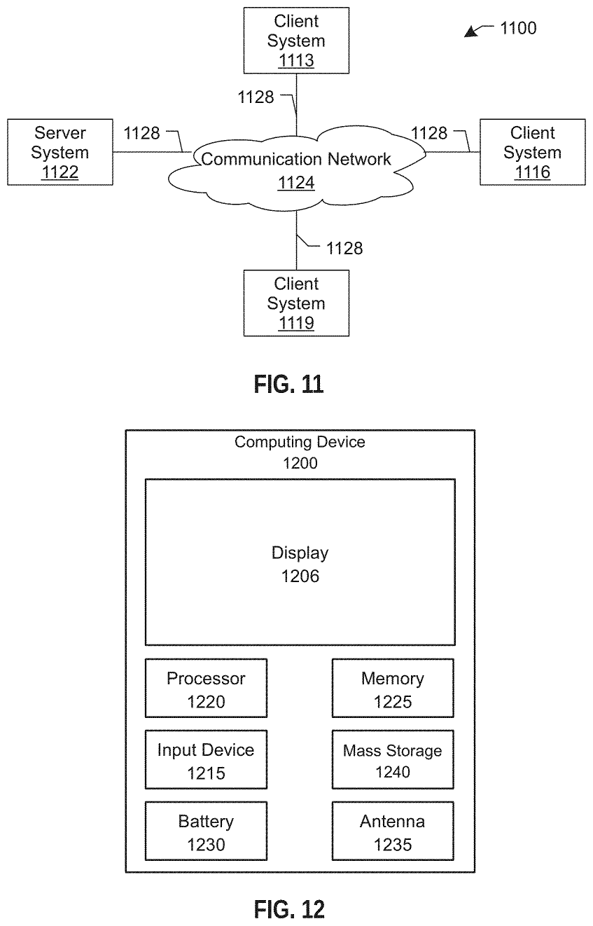

FIG. 11 shows a simplified block diagram of an embodiment of a distributed computer system supporting a real-time operational coordination platform for law enforcement operations using a standardized operational plan. Computer network 1100 includes a number of client systems 1113, 1116, and 1119, and a server system 1122 coupled to a communication network 1124 via a plurality of communication links 1128. Communication network 1124 provides a mechanism for allowing the various components of distributed network 1100 to communicate and exchange information with each other.

Communication network 1124 may itself be comprised of many interconnected computer systems and communication links. Communication links 1128 may be hardwire links, optical links, satellite or other wireless communications links, wave propagation links, or any other mechanisms for communication of information. Various communication protocols may be used to facilitate communication between the various systems shown in FIG. 11. These communication protocols may include TCP/IP, HTTP protocols, wireless application protocol (WAP), vendor-specific protocols, customized protocols, and others. While in one embodiment, communication network 1124 is the Internet, in other embodiments, communication network 1124 may be any suitable communication network including a local area network (LAN), a wide area network (WAN), a wireless network, a intranet, a private network, a public network, a switched network, Internet telephony, IP telephony, digital voice, voice over broadband (VoBB), broadband telephony, Voice over IP (VoIP), public switched telephone network (PSTN), and combinations of these, and the like.

System 1100 in FIG. 11 is merely illustrative of an embodiment and does not limit the scope of the systems and methods as recited in the claims. One of ordinary skill in the art would recognize other variations, modifications, and alternatives. For example, more than one server system 1122 may be connected to communication network 1124. As another example, a number of client systems 1113, 1116, and 1119 may be coupled to communication network 1124 via an access provider (not shown) or via some other server system. An instance of a server system 1122 and a client system 1113 may be part of the same or a different hardware system. An instance of a server system 1122 may be operated by a provider different from an organization operating an embodiment of a system for specifying an object in a design, or may be operated by the same organization operating an embodiment of a system for specifying an object in a design.

Client systems 1113, 1116, and 1119 typically request information from a server system 1122 which provides the information. Server systems by definition typically have more computing and storage capacity than client systems. However, a particular computer system may act as both a client and a server depending on whether the computer system is requesting or providing information. Aspects of the system may be embodied using a client-server environment or a cloud-cloud computing environment.

Server 1122 is responsible for receiving information requests from client systems 1113, 1116, and 1119, performing processing required to satisfy the requests, and for forwarding the results corresponding to the requests back to the requesting client system. The processing required to satisfy the request may be performed by server system 1122 or may alternatively be delegated to other servers connected to communication network 1124.

Client systems 1113, 1116, and 1119 permit users to access and query information or applications stored by server system 1122. Some example client systems include portable electronic devices (e.g., mobile communication devices) such as the Apple iPhone®, the Apple iPad®, the Palm Pre™, or any device running the Apple iOS™, Android™ OS, Google Chrome OS, Symbian OS®, Windows Mobile® OS, Palm OS® or Palm Web OS™. In a specific embodiment, a “web browser” application executing on a client system enables users to select, access, retrieve, or query information and/or applications stored by server system 1122. Examples of web browsers include the Android browser provided by Google, the Safari® browser provided by Apple, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others. Client systems 1113, 1116, and 1119 may run applications to enable users remotely operate switches according to various embodiments.

FIG. 12 shows a more detailed diagram of an example of a computing device from a system supporting a one-to-many transmitter device for access points. In an embodiment, a user interfaces with the system through a client system, such as shown in FIG. 12. Mobile client communication device or portable electronic device 1200 includes a display, screen, or monitor 1206 and a input device 1215 stored within a single housing 1200. Housing 1200 houses familiar computer components, some of which are not shown, such as a processor 1220, memory 1225, battery 1230, speaker, transceiver, network interface/antenna 1235, microphone, ports, jacks, connectors, camera, input/output (I/O) controller, display adapter, network interface, mass storage devices 1240, and the like. Computer system 1200 may include a bus or other communication mechanism for communicating information between components. Mass storage device (or devices) 1240 may store a user application and system software components. Memory 1225 may store information and instructions to be executed by processor 1220.

Input device 1215 may also include a touchscreen (e.g., resistive, surface acoustic wave, capacitive sensing, infrared, optical imaging, dispersive signal, or acoustic pulse recognition), keyboard (e.g., electronic keyboard or physical keyboard), buttons, switches, stylus, gestural interface (contact or non-contact gestures), biometric input sensors, or combinations of these.

Mass storage device 1240 may include flash and other nonvolatile solid-state storage or solid-state drive (SSD), such as a flash drive, flash memory, or USB flash drive. Other examples of mass storage include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), battery-backed-up volatile memory, tape storage, reader, and other similar media, and combinations of these.

System 100 may also be used with computer systems having different configurations, e.g., with additional or fewer subsystems. For example, a computer system could include more than one processor (i.e., a multiprocessor system, which may permit parallel processing of information) or a system may include a cache memory. The computer system shown in FIG. 12 is but an example of a computer system suitable for use. Other configurations of subsystems suitable for use will be readily apparent to one of ordinary skill in the art. For example, in a specific implementation, the computing device is mobile communication device such as a smartphone or tablet computer. Some specific examples of smartphones include the Droid Incredible and Google Nexus One®, provided by HTC Corporation, the iPhone® or iPad®, both provided by Apple, BlackBerry Z10 provided by BlackBerry (formerly Research In Motion), and many others. The computing device may be a laptop or a netbook. In another specific implementation, the computing device is a non-portable computing device such as a desktop computer or workstation.

A computer-implemented or computer-executable version of the program instructions useful to practice the present subject matter may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software useful to practice the present subject matter may be stored or reside in RAM or cache memory, or on mass storage device 1240. The source code of this software may also be stored or reside on mass storage device 1240 (e.g., flash drive, hard disk, magnetic disk, tape, or CD-ROM). As a further example, code useful for practicing the subject matter may be transmitted via wires, radio waves, or through a network such as the Internet. In another specific embodiment, a computer program product including a variety of software program code to implement features of the subject matter is provided.

Computer software products may be written in any of various suitable programming languages, such as C, C++, C #, Pascal, Fortran, Perl, Matlab (from MathWorks, www.mathworks.com), SAS, SPSS, JavaScript, CoffeeScript, Objective-C, Objective-J, Ruby, Python, Erlang, Lisp, Scala, Clojure, and Java. The computer software product may be an independent application with data input and data display modules. Alternatively, the computer software products may be classes that may be instantiated as distributed objects. The computer software products may also be component software such as Java Beans (from Oracle) or Enterprise Java Beans (EJB from Oracle).

An operating system for the system may be the Android operating system, iPhone OS (i.e., iOS), Symbian, BlackBerry OS, Palm web OS, bada, MeeGo, Maemo, Limo, or Brew OS. Other examples of operating systems include one of the Microsoft Windows family of operating systems (e.g., Windows 95, 98, Me, Windows NT, Windows 2000, Windows XP, Windows XP x64 Edition, Windows Vista, Windows 7, Windows CE, Windows Mobile, Windows Phone 7), Linux, HP-UX, UNIX, Sun OS, Solaris, Mac OS X, Alpha OS, AIX, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system useful in practicing the subject matter using a wireless network employing a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In a first enumerated embodiment, A method comprises: creating, by a processor of an application server having memory, a law enforcement operational plan display from a stored template in response to receiving a request for a law enforcement operational plan from a team leader device over a network connection, the team leader device having been previously authenticated as being an administrator by a security server, the law enforcement operational plan display being a graphic user interface illustrating a plurality of fields associated with different data associated with the law enforcement operations plan; providing, by the processor for display on the team leader device, a plurality of predetermined prompts for receiving specified data, the predetermined prompts being derived from the stored template; receiving, by the processor via the network connection from the team leader device, team leader input data associated with one or more of the displayed predetermined prompts; storing, by the processor, the team leader input data into a record associated with the law enforcement operational plan display, the team leader input data comprising messages from the team leader device, identities and geolocations associated with a plurality of operator devices, files representing documents and image data associated with the law enforcement operational plan, and customizable image data; receiving, by the processor via the network connection from the plurality of operator devices, operator input data including messages, geolocation information and other operational data; storing, by the processor, the operator input data into the record associated with the law enforcement operations plan display; broadcasting, by the processor over the network connection, using a websocket push system to maintain persistent connections, the stored team leader input data and the stored operator input data to the plurality of operator devices, the broadcasting causing the stored team leader input data and stored operator input data to be displayed in a field of the law enforcement operations plan display of each of the plurality of operator devices; and causing, by the processor, the operations plan display of each of the plurality of operator devices to be updated substantially in real-time with subsequently-received team leader input data and subsequently-received operator input data in response to the processor receiving each subsequently-received team leader input data and each subsequently-received operator input data.

What is claimed is:

1. A method comprising:
creating, by a processor of an application server having memory, a law enforcement operations plan display from a stored template in response to receiving a request for a law enforcement operations plan from a team leader device over a network connection, the team leader device having been previously authenticated as being an administrator by a security server, the law enforcement operations plan display being a graphic user interface illustrating a plurality of fields associated with different data associated with the law enforcement operations plan;
providing, by the processor for display on the team leader device, a plurality of predetermined prompts for receiving specified data, the predetermined prompts being derived from the stored template;
receiving, by the processor via the network connection from the team leader device, team leader input data associated with one or more of the displayed predetermined prompts;
storing, by the processor, the team leader input data into a record associated with the law enforcement operations plan display, the team leader input data comprising messages from the team leader device, identities and geolocations associated with a plurality of operator devices, files representing documents and image data associated with the law enforcement operations plan, and customizable image data;
receiving, by the processor via the network connection from the plurality of operator devices, operator input data including messages, geolocation information and other operational data;
storing, by the processor, the operator input data into the record associated with the law enforcement operations plan display
broadcasting, by the processor over the network connection, using a websocket push system to maintain persistent connections, the stored team leader input data and the stored operator input data to the plurality of operator devices, the broadcasting causing the stored team leader input data and stored operator input data to be displayed in a field of the law enforcement operations plan display of each of the plurality of operator devices; and
causing, by the processor, the operations plan display of each of the plurality of operator devices to be updated substantially in real-time with subsequently-received team leader input data and subsequently-received operator input data in response to the processor receiving each subsequently-received team leader input data and each subsequently-received operator input data.

2. The method of claim 1, further comprising storing in a database a snapshot of the record including all input data received from the team leader device and from the operator devices.

3. The method of claim 2, the database being a blockchain database.

4. The method of claim 1, the geolocations of the operator devices being received at the processor via an application programming interface between an operator device client application in communication with the processor via the network connection and geolocation services running on the operator devices.

5. The method of claim 1, the predetermined prompts being presented in a checklist format, where the predetermined prompts include prompts for the documents associated with the operations plan and the customized image data.

6. The method of claim 1, further comprising receiving confirmation from each of the operator devices in response to transmitting, by the processor, notifications to each of the operator devices of initializing the operations plan, and transmitting, by the processor, to the operator devices the operations plan display in response to receiving the confirmations from each of the operator devices.

7. A computer program product comprising computer-readable program code to be executed by one or more processors when retrieved from a non-transitory computer-readable medium, the program code including instructions to:
create, by a processor of an application server having memory, a law enforcement operations plan display from a stored template in response to receiving a request for a law enforcement operations plan from a team leader device over a network connection, the team leader device having been previously authenticated as being an administrator by a security server, the law enforcement operations plan display being a graphic user interface illustrating a plurality of fields associated with different data associated with the law enforcement operations plan;
provide, by the processor for display on the team leader device, a plurality of predetermined prompts for receiving specified data, the predetermined prompts being derived from the stored template;
receive, by the processor via the network connection from the team leader device, team leader input data associated with one or more of the displayed predetermined prompts;
store, by the processor, the team leader input data into a record associated with the law enforcement operations plan display, the team leader input data comprising messages from the team leader device, identities and geolocations associated with a plurality of operator devices, files representing documents and image data associated with the law enforcement operations plan, and customizable image data;
receive, by the processor via the network connection from the plurality of operator devices, operator input data including messages, geolocation information and other operational data;
store, by the processor, the operator input data into the record associated with the law enforcement operations plan display
broadcast, by the processor over the network connection, using a websocket push system to maintain persistent connections, the stored team leader input data and the stored operator input data to the plurality of operator devices, the broadcasting causing the stored team leader input data and stored operator input data to be displayed in a field of the law enforcement operations plan display of each of the plurality of operator devices; and
cause, by the processor, the operations plan display of each of the plurality of operator devices to be updated substantially in real-time with subsequently-received team leader input data and subsequently-received operator input data in response to the processor receiving each subsequently-received team leader input data and each subsequently-received operator input data.

8. The computer program product of claim 7, the computer program product further comprising instructions to store in a database a snapshot of the record including all input data received from the team leader device and from the operator devices.

9. The computer program product of claim 8, the database being a blockchain database.

10. The computer program product of claim 7, the geolocations of the operator devices being received at the processor via an application programming interface between an operator device client application in communication with the processor via the network connection and geolocation services running on the operator devices.

11. The computer program product of claim 7, the predetermined prompts being presented in a checklist format, where the predetermined prompts include prompts for the documents associated with the operations plan and the customized image data.

12. The computer program product of claim 7, the computer program product further comprising instructions to receive confirmation from each of the operator devices in response to transmitting, by the processor, notifications to each of the operator devices of initializing the operations plan, and transmitting, by the processor, to the operator devices the operations plan display in response to receiving the confirmations from each of the operator devices.

13. A system comprising:
one or more processors; and
a non-transitory computer readable medium storing a plurality of instructions, which when executed, cause the one or more processors to:
create, by a processor of an application server having memory, a law enforcement operations plan display from a stored template in response to receiving a request for a law enforcement operations plan from a team leader device over a network connection, the team leader device having been previously authenticated as being an administrator by a security server, the law enforcement operations plan display being a graphic user interface illustrating a plurality of fields associated with different data associated with the law enforcement operations plan;
provide, by the processor for display on the team leader device, a plurality of predetermined prompts for receiving specified data, the predetermined prompts being derived from the stored template;
receive, by the processor via the network connection from the team leader device, team leader input data associated with one or more of the displayed predetermined prompts;
store, by the processor, the team leader input data into a record associated with the law enforcement operations plan display, the team leader input data comprising messages from the team leader device, identities and geolocations associated with a plurality of operator devices, files representing documents and image data associated with the law enforcement operations plan, and customizable image data;
receive, by the processor via the network connection from the plurality of operator devices, operator input data including messages, geolocation information and other operational data;
store, by the processor, the operator input data into the record associated with the law enforcement operations plan display
broadcast, by the processor over the network connection, using a websocket push system to maintain persistent connections, the stored team leader input data and the stored operator input data to the plurality of operator devices, the broadcasting causing the stored team leader input data and stored operator input data to be displayed in a field of the law enforcement operations plan display of each of the plurality of operator devices; and
cause, by the processor, the operations plan display of each of the plurality of operator devices to be updated substantially in real-time with subsequently-received team leader input data and subsequently-received operator input data in response to the processor receiving each subsequently-received team leader input data and each subsequently-received operator input data.

14. The system of claim 13, the instructions further comprising instructions to store in a database a snapshot of the record including all input data received from the team leader device and from the operator devices.

15. The system of claim 14, the database being a blockchain database.

16. The system of claim 13, the geolocations of the operator devices being received at the processor via an application programming interface between an operator device client application in communication with the processor via the network connection and geolocation services running on the operator devices.

17. The system of claim 15, the predetermined prompts being presented in a checklist format, where the predetermined prompts include prompts for the documents associated with the operations plan and the customized image data.
